(19) United States
(12) Patent Application Publication
(10) Pub. No.: US 2025/0103036 A1
(43) Pub. Date: Mar. 27, 2025

(54) Abnormality Diagnosis Device and Method Thereof

(71) Applicant: Hitachi, Ltd., Chiyoda-ku, Tokyo (JP)

(72) Inventors: Shuichi NISHINO, Tokyo (JP); Kenichi SHIMBO, Tokyo (JP); Yutaka UEMATSU, Tokyo (JP)

(21) Appl. No.: 18/728,289

(22) PCT Filed: Nov. 10, 2022
(86) PCT No.: PCT/JP2022/041955

§ 371 Date: Jul. 11, 2024

(30) Foreign Application Priority Data
Feb. 28, 2022 (JP) 2022-029736

(51) Int. Cl. G05B 23/02

(52) U.S. Cl. CPC G05B 23/0243

(57) ABSTRACT

In an abnormality diagnosis device which estimates an abnormality degree, an abnormality factor, and the like of a target from data, a description of a diagnosis reason is presented in association with diagnosis knowledge of an operator, so that the operator can easily understand the description presentation. Therefore, the abnormality diagnosis device includes an abnormality diagnosis unit which diagnoses an abnormality of a diagnosis target using data related to the diagnosis target as an input, a description presentation unit which presents a description corresponding to the abnormality of the diagnosis target based on a result of diagnosis by the abnormality diagnosis unit, and a display unit which displays the description corresponding to the abnormality of the diagnosis target presented by the description presentation unit on a screen.

### TECHNICAL FIELD

The present invention relates to an abnormality diagnosis device and a method thereof.

### BACKGROUND ART

In an abnormality diagnosis device that estimates an abnormality degree, an abnormality factor, and the like of a target from data, there is a technology described in PLT 1 as a technology that presents a description of a reason for the diagnosis (hereinafter, referred to as a description presentation technique). There is a description of “comprising: an extraction unit which extracts a plurality of features from an image including an inspection target; a determination unit which determines an abnormality degree of the inspection target based on the extracted features; a map generation unit which generates a plurality of score maps representing scores of the respective features from the image; and an image generation unit which generates a defect display image representing a defect serving as a basis for determination that the inspection target is abnormal by integrating the plurality of score maps based on contributions of the respective features to the abnormality degree determined by the determination unit” in this publication.

### CITATION LIST

### Patent Literature

PTL 1: JP 2016-114592 A

### SUMMARY OF INVENTION

### Technical Problem

The description presentation technique for describing the result of the abnormality diagnosis presents the reason for the abnormality diagnosis, so that a user of the abnormality diagnosis device (hereinafter, referred to as an operator) can use it for determination of validity of the diagnosis result, creation of a diagnosis report, and the like.

However, in the conventional description presentation technique, there is a problem that it is difficult for an operator to understand the description in a case where the diagnosis knowledge about the abnormality possessed by the operator does not correspond to the description presented by the device.

For example, in PTL 1, the description is presented using a feature contributing to diagnosis. The feature is data related to an abnormality diagnosis target, and is, for example, an image or sensor data acquired from the abnormality diagnosis target or a modification thereof, and there are various design methods. The feature is not necessarily designed to be easily understood by an operator, for example, designed so that the designer of the abnormality diagnosis device enhances the accuracy of the abnormality diagnosis. Therefore, in the method of PTL 1, there is a possibility that an operator can understand the description only when the operator has knowledge about the feature.

The present invention solves the above-described problems of the prior art, and provides an abnormality diagnosis device and a method thereof capable of presenting a description of a diagnosis reason in association with diagnosis knowledge of an operator so that the operator can easily understand the description presentation.

### Solution to Problem

In order to solve the above problems of the prior art, in the present invention, an abnormality diagnosis device includes an abnormality diagnosis unit which diagnoses an abnormality of a diagnosis target using data related to the diagnosis target as an input, a description presentation processing unit which presents a description corresponding to an abnormality of a diagnosis target based on a result of diagnosis by the abnormality diagnosis unit, and a display unit which displays a description corresponding to an abnormality of a diagnosis target presented by the description presentation processing unit on a screen.

In order to solve the above problems, in the present invention, an abnormality diagnosis method includes diagnosing an abnormality of a diagnosis target by an abnormality diagnosis unit using data related to the diagnosis target as an input, presenting a description corresponding to an abnormality of a diagnosis target by a description presentation processing unit based on a result of diagnosis by the abnormality diagnosis unit, and displaying a description corresponding to an abnormality of a diagnosis target presented by the description presentation processing unit on a screen of a display unit.

### Advantageous Effects of Invention

According to the present invention, it is possible to present a description that is easy understood by an operator by presenting a description of a diagnosis reason in association with the existing knowledge of the operator.

Problems, configurations, and effects other than those described above will be clarified by the following description of embodiments.

### BRIEF DESCRIPTION OF DRAWINGS

FIG. 1 is a block diagram illustrating a schematic configuration of an abnormality diagnosis device according to a first embodiment of the present invention.

FIG. 2 is a flowchart illustrating a flow of processing executed by a description presentation model execution unit according to the first embodiment of the present invention.

FIG. 3A is a diagram illustrating an example of diagnosis knowledge according to the first embodiment of the present invention, and is a diagram illustrating a relationship between a confirmation item and a diagnosis result in a case where the confirmation item is an abnormal vibration.

FIG. 3B is a diagram illustrating an example of diagnosis knowledge according to the first embodiment of the present invention, and is a diagram illustrating a relationship between a confirmation item and a diagnosis result in a case where the confirmation item is a motor current radio frequency abnormality.

FIG. 3C is a diagram illustrating an example of diagnosis knowledge according to the first embodiment of the present invention, and is a diagram illustrating a relationship between a confirmation item and a diagnosis result in a case where the confirmation item is a magnitude relationship between a position error and a threshold.

FIG. 4 is a front view of a screen illustrating an example of a description presentation screen according to the first embodiment of the present invention.

FIG. 5 is a flowchart illustrating a flow of processing of an abnormality diagnosis process and a description presentation process according to the first embodiment of the present invention.

FIG. 6 is a front view of a screen illustrating an example of a description presentation screen according to a second embodiment of the present invention.

FIG. 7 is a block diagram illustrating a schematic configuration of an abnormality diagnosis device according to a third embodiment of the present invention.

FIG. 8 is a flowchart illustrating a flow of processing of training in a training unit according to the third embodiment of the present invention.

FIG. 9 is a schematic diagram illustrating a hardware configuration of an information processing device.

FIG. 10 is a diagram illustrating an example of a program and data stored in a storage device in the abnormality diagnosis device according to the first or second embodiment of the present invention.

FIG. 11 is a diagram illustrating an example of a program and data stored in a storage device in the abnormality diagnosis device according to the third embodiment of the present invention.

### DESCRIPTION OF EMBODIMENTS

In an abnormality diagnosis device that identifies the presence or absence, degree, and factor of abnormality in diagnosis of artificial intelligence (AI) based on acquired data and past cases, it is required to present a description of a diagnosis reason in order to be used as a reference for determination of validity of a diagnosis result and preparation of a diagnosis report. In the present invention, a diagnosis reason including a countermeasure is indicated in association with a confirmation item at the time of manual diagnosis by using a description presentation model for predicting a confirmation item and a confirmation result of the confirmation item that an operator has referred to at the time of manual diagnosis from processing information of a diagnosis model, so as to present a description which is easily understood by the operator.

That is, in the present invention, the abnormality diagnosis device includes a definition unit which defines the diagnosis knowledge related to the abnormality diagnosis, acquires processing information of a diagnosis model which estimates an abnormality degree, an abnormality factor, and the like of a target from a feature, presents a description of a diagnosis reason of the diagnosis model in association with the diagnosis knowledge by a description presentation model which predicts a diagnosis knowledge item from the processing information, and presents the description of the diagnosis reason including a countermeasure in association with an existing knowledge of an operator, so as to present a description which is easily understood by the operator.

Hereinafter, embodiments of the present invention will be described with reference to the drawings. In all the drawings for describing the embodiments, the same members are denoted by the same reference numerals in principle, and repeated description thereof will be omitted. In addition, in the following embodiments, it is needless to say that the constituent elements (including element steps and the like) are not necessarily essential unless otherwise specified or considered to be obviously essential in principle. In addition, it is needless to say that the terms “comprising A”, “consisting of A”, “having A”, and “including A” do not exclude other elements except for a case where only the element is specifically stated. Similarly, in the following embodiments, when referring to the shape, positional relationship, and the like of the components and the like, it is assumed to include those substantially approximate or similar to the shape and the like unless otherwise specified or unless clearly considered to be in principle.

### First Embodiment

Here, an abnormality diagnosis device that presents a description associated with diagnosis knowledge regarding a diagnosis reason of a diagnosis model will be described using an abnormality diagnosis for a robot as an example.

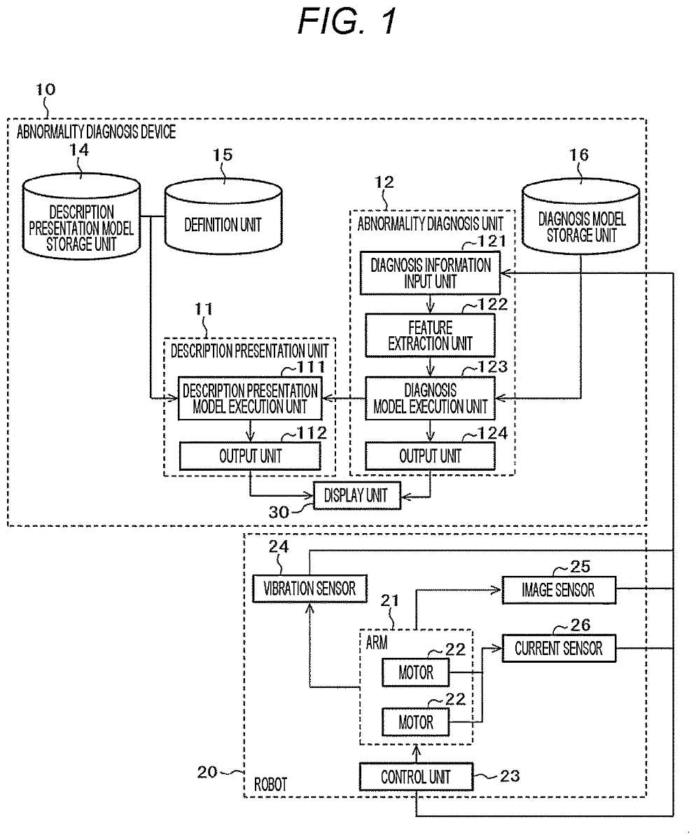

FIG. 1 is a diagram illustrating a configuration example of an abnormality diagnosis device according to a first embodiment of the present invention.

A robot 20 is a robot which performs a gripping and assembling operation as an abnormality diagnosis target, and includes an arm 21, a control unit 23, a current sensor 26, a vibration sensor 24, and an image sensor 25.

The arm 21 is a movable portion of the robot, and a motor 22 is a motor for driving the arm. The control unit 23 is a control unit which causes the arm 21 to realize a desired operation. In order to cause the arm 21 to realize a desired operation, the control unit 23 first determines a target moving amount of each unit, and then drives the motor 22 to control the arm 21. For example, the control unit 23 can be formed of a control board including a central processing unit (CPU), a random access memory (RAM), and a read only memory (ROM), or a microcomputer.

The vibration sensor 24 is a sensor which measures a vibration amount of the arm 21. The image sensor 25 is a sensor which measures an actual measurement value of the moving amount of the arm 21. The current sensor 26 is a sensor which measures a current value of the motor 22.

An abnormality diagnosis device 10 is a device which performs abnormality diagnosis and description presentation of a diagnosis reason thereof to the robot 20, and includes a description presentation unit 11, an abnormality diagnosis unit 12, a description presentation model storage unit 14, a definition unit 15, and a diagnosis model storage unit 16. The description presentation unit 11, the abnormality diagnosis unit 12, and the description presentation model storage unit 14 may be collectively referred to as a description presentation processing unit.

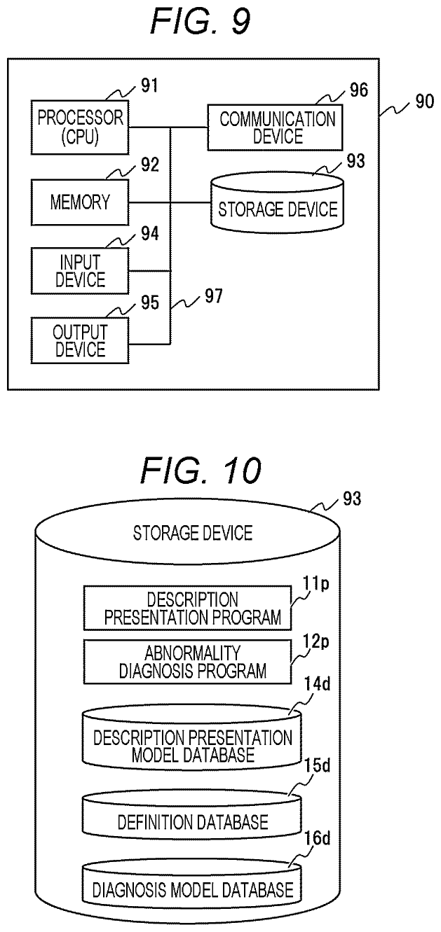

The abnormality diagnosis device 10 is realized by an information processing device 90 including a processor (CPU) 91, a memory (RAM) 92, a storage device 93, an input device 94, an output device 95, a communication device 96, and a bus 97 as illustrated in FIG. 9 as main components. The processor 91 functions as a functional unit (functional block) which provides a predetermined function by executing processing according to a program loaded in the memory 92. The storage device 93 stores data used in the functional unit in addition to the program causing the functional unit to function. As the storage device 93, for example, a non-volatile storage medium such as a hard disk drive (HDD) or a solid state drive (SSD) is used. The input device 94 is a keyboard, a pointing device, or the like, and the output device 95 is a display or the like. The input device 94 and the output device 95 may be integrated using a touch panel. The communication device 96 enables communication with another information processing device via a network. These components are communicably connected to each other by the bus 97.

Note that the abnormality diagnosis device 10 does not need to be implemented by one information processing device, and may be implemented by a plurality of information processing devices. In addition, some or all of the functions of the abnormality diagnosis device 10 may be realized as an application on a cloud.

FIG. 10 illustrates programs and data stored in the storage device 93. A description presentation program 11p and an abnormality diagnosis program 12p are each loaded into the memory 92 and executed by the processor 91, thereby causing the processor 91 to function as the description presentation unit 11 or the abnormality diagnosis unit 12. Data stored in the description presentation model storage unit 14, the definition unit 15, and the diagnosis model storage unit 16 is stored in the storage device 93 as a description presentation model database 14d a definition database 15d, and a diagnosis model database 16d, respectively.

The abnormality diagnosis unit 12 is a functional unit which performs abnormality diagnosis processing to the robot 20, and includes a diagnosis information input unit 121, a feature extraction unit 122, a diagnosis model execution unit 123, and an output unit 124 as sub-functional units.

The diagnosis information input unit 121 is an input unit which receives the vibration amount measured by the vibration sensor 24 of the robot 20, the target moving amount determined by the control unit 23, the actual measurement value of the moving amount measured by the image sensor 25, and the current value measured by the current sensor 26 as diagnosis information and delivers the diagnosis information to the feature extraction unit.

The feature extraction unit 122 is a functional unit which performs processing of extracting a feature of a data format suitable for input to the diagnosis model execution unit 123 from the diagnosis information received from the diagnosis information input unit 121. An example of the feature extraction processing may include converting the feature into a data format having a high correlation with abnormality so that the diagnosis model execution unit 123 can realize highly accurate abnormality diagnosis, and processing of applying frequency conversion to the current sensor to extract harmonic components and the like is considered. In addition, the received data may not be modified.

The diagnosis model execution unit 123 is a functional unit which performs processing of reading the diagnosis model from the diagnosis model storage unit 16, inputting the feature extracted by the feature extraction unit 122 to the diagnosis model read from the diagnosis model storage unit 16, executing the diagnosis model, and obtaining a diagnosis result as an output of the diagnosis model. The diagnosis result is output to the output unit 124 and a description presentation model execution unit 111 of the description presentation unit 11 described later.

Here, the diagnosis model stored in the diagnosis model storage unit 16 is, for example, a machine learning model such as a trained neural network, and a machine learning model in which a relationship between a feature and a diagnosis result has been trained based on a past abnormal case is stored. The diagnosis result may be the presence or absence, or the degree of abnormality of the diagnosis target, or may be an estimated factor. The diagnosis result may be a countermeasure to be taken against the abnormality.

The output unit 124 outputs the diagnosis result received from the diagnosis model execution unit to the display unit 30. The display unit 30 is an example of the output device 95 in FIG. 9. In addition to the display unit 30, for example, it may be stored in a storage or transmitted to an external processing terminal via a communication line. It may also possible to emit an alert sound from an unillustrated alarm or to allow an unillustrated notification lamp to blink in a case where an abnormality is detected in the robot 20.

The description presentation unit 11 is a functional unit which performs processing of presenting a description of a diagnosis reason of the abnormality diagnosis unit 12, and includes the description presentation model execution unit 111 and an output unit 112 as sub-functional units.

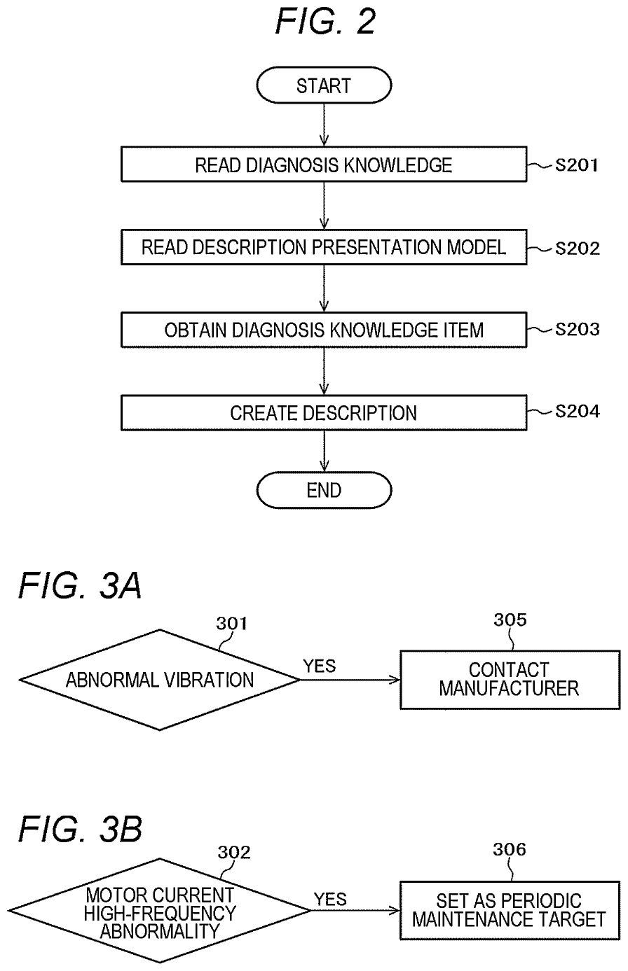

The description presentation model execution unit 111 is processing of executing steps S201 to S204 illustrated in FIG. 2.

S201: Diagnosis knowledge is read from the definition unit 15. Here, the definition unit 15 is a portion which holds diagnosis knowledge including a plurality of diagnosis knowledge items, and the diagnosis knowledge item is, for example, relationship information between a confirmation item and a diagnosis result in a case where an operator manually performs diagnosis.

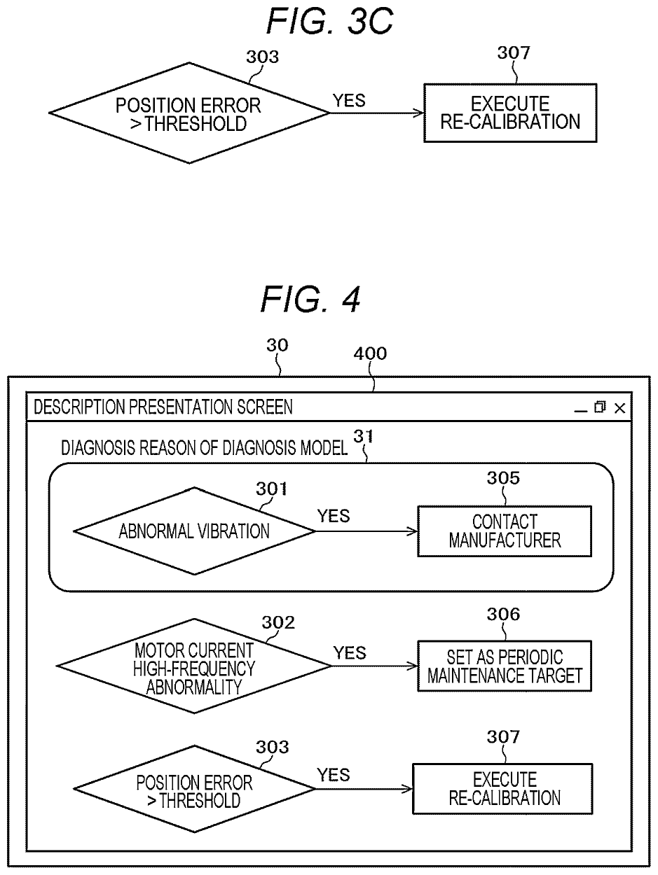

FIGS. 3A to 3C show examples of such relationship information, and they indicate that the diagnosis results each in a case where the confirmation results of the confirmation item 301 in FIG. 3A, the confirmation item 302 in FIG. 3B, and the confirmation item 303 in FIG. 3C are YES are the diagnosis result 305 in FIG. 3A, the diagnosis result 306 in FIG. 3B, and the diagnosis result 307 in FIG. 3C, which are connected by arrows, respectively. For example, the relationship information including a pair of the confirmation item 301 and the diagnosis result 305 in FIG. 3A means a diagnosis knowledge item of “in a case where the vibration sensor 24 of the robot 20 detects abnormal vibration, contact the robot manufacturer”.

S202: The description presentation model is read from the description presentation model storage unit 14. Here, the description presentation model storage unit 14 holds a machine learning model in which a correspondence between processing information reflecting a diagnosis process by the diagnosis model execution unit 123 from a past abnormal case and a diagnosis knowledge item included in the diagnosis knowledge is trained as a description presentation model. As an example of the processing information, in a case where the diagnosis model executed by the diagnosis model execution unit 123 is a neural network, it is considered to use vector information of the intermediate layer when the neural network is executed as the processing information. An example of the diagnosis knowledge item associated with the processing information includes, for example, a pair of the confirmation item 301 and the diagnosis result 305 in FIG. 3A.

S203: The processing information about the diagnosis which is to be a description presentation target is acquired from the diagnosis model execution unit 123 and input to the description presentation model execution unit 111, and is executed by the description presentation model execution unit 111 to obtain a diagnosis knowledge item corresponding to the processing information as an output. The obtained diagnosis knowledge item reflects processing information of the diagnosis model, and can be regarded as a diagnosis reason of the diagnosis model.

S204: The diagnosis knowledge item obtained in S203 and the diagnosis knowledge read from the definition unit 15 will be transmitted to the output unit 112 as a description.

The output unit 112 outputs the description received from the description presentation model execution unit 111 to the display unit 30 as a diagnosis result. In addition to the display unit 30, for example, it may be stored in a storage or transmitted to an external processing terminal via a communication line.

FIG. 4 illustrates an example in which a description presentation model is output as the description presentation screen 400 on the display unit 30. As the relationship information of the diagnosis knowledge, the pair of the confirmation item 301 and the diagnosis result 305 illustrated in FIG. 3A, the pair of the confirmation item 302 and the diagnosis result 306 illustrated in FIG. 3B, and the pair of the confirmation item 303 and the diagnosis result 307 illustrated in FIG. 3C are indicated, and the pair corresponding to the diagnosis knowledge item that is the diagnosis reason of the diagnosis model is surrounded by a frame line 31.

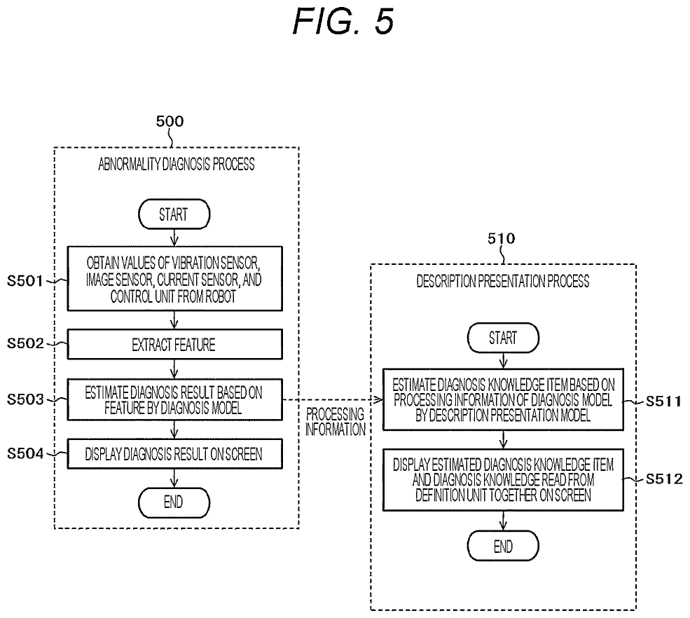

FIG. 5 illustrates an example of a flowchart of processing in the present embodiment.

First, in an abnormality diagnosis process 500 executed by the abnormality diagnosis unit 12, when the operation is started, data of the vibration sensor 24, the image sensor 25, the current sensor 26, and the control unit 23 of the robot 20 are input to the diagnosis information input unit 121 (S501). The feature extraction unit 122 extracts a feature from the data input to the diagnosis information input unit 121 (S502).

Next, the diagnosis model execution unit 123 inputs the feature extracted by the feature extraction unit 122 to the diagnosis model read from the diagnosis model storage unit 16 to estimate a diagnosis result (S503), outputs from the output unit 124 to the display unit 30, and displays on the screen of the display unit 30 (S504), and the processing ends.

In this case, as the estimated diagnosis result, boxes 305, 306, and 307 in FIG. 4 and arrows connected thereto are not displayed on the screen of the display unit 30, and boxes 301, 302, and 303 are displayed in a state where one of them is surrounded by a frame line 31.

On the other hand, in a description presentation process 510 executed by the description presentation unit 11, when the operation is started, the description presentation model execution unit 111 acquires information of the diagnosis result estimated by the diagnosis model execution unit 123, inputs to the description presentation model read from the description presentation model storage unit 14, and estimates a corresponding diagnosis knowledge item (S511).

The output unit 112 outputs the diagnosis knowledge item estimated in the description presentation model execution unit 111 and the diagnosis knowledge read from the definition unit 15 together to the display unit 30, and displays the diagnosis knowledge item and the diagnosis knowledge on the screen of the display unit 30 in the form described in FIG. 4, for example (S512), and the processing ends.

The diagnosis result is displayed as the information in which the confirmation item and the diagnosis result when the operator manually performs the diagnosis are associated with each other as described in FIG. 4, that is, the description of the diagnosis reason is presented in association with the existing diagnosis knowledge of the operator, so that the cause of the abnormality and the countermeasure are displayed as the information in which the cause of the abnormality and the countermeasure are associated with each other, whereby the operator can easily understand the description.

As described above, according to the present embodiment, regarding the abnormality of the diagnosis target diagnosed by the abnormality diagnosis unit, it is possible to present the description of the reason for the diagnosis in association with the existing diagnosis knowledge of the operator, and it is possible to present the description that is easily understood for the operator.

### Second Embodiment

As a second embodiment of the present invention, as in the case of the first embodiment, an abnormality diagnosis device capable of presenting a description linked to diagnosis knowledge including a combination and an order of a plurality of confirmation items by associating a diagnosis reason of a diagnosis model with a diagnosis flow representing a procedure in a case where an operator manually performs diagnosis will be described using an abnormality diagnosis for a robot as an example.

The configuration of the abnormality diagnosis device 10 according to the present embodiment is the same as that described in the first embodiment with reference to FIG. 1, and thus the description thereof will be omitted.

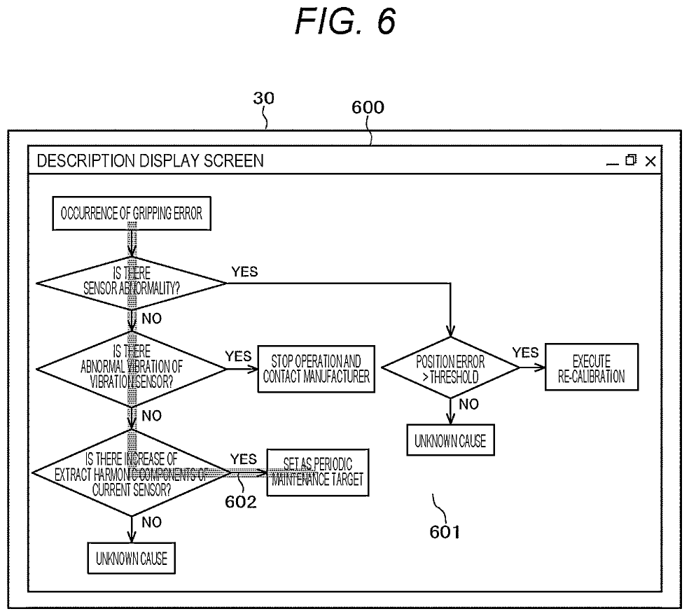

In the first embodiment, as an example of the relationship information held by the definition unit 15, information in which a cause of an abnormality is individually associated with a countermeasure therefor as illustrated in FIGS. 3A to 3C is used, and the information as illustrated in the description presentation screen 400 of FIG. 4 is displayed on the screen as information in which a confirmation item and a diagnosis result are associated with each other in a case where the operator manually performs diagnosis. In the present embodiment, an example will be described in which an abnormality diagnosis flow 601 as illustrated in FIG. 6 is displayed on a screen, and a cause of an abnormality and a countermeasure therefor are displayed along a flow of abnormality diagnosis processing on the abnormality diagnosis flow 601.

That is, in the present embodiment, an example of the diagnosis knowledge item associated with the processing information in the description presentation model stored in the description presentation model storage unit 14 is a diagnosis path 602 on the abnormality diagnosis flow 601 in a case where the operator manually performs diagnosis as illustrated in a description display screen 600 of FIG. 6, and is the diagnosis knowledge item expressed as a combination in consideration of the order of the confirmation items in a case where the operator manually performs diagnosis. That is, it is a diagnosis flow that branches depending on a confirmation item and a confirmation result thereof and leads to a diagnosis result.

In the present embodiment, the information output from the output unit 112 and displayed on the display unit 30 is illustrated, as an abnormality diagnosis result as shown in a diagnosis path 602, the abnormality detected by the abnormality diagnosis unit 12 and the countermeasure associated with the cause of the abnormality by the description presentation unit 11 along the processing flow of the abnormality diagnosis on the abnormality diagnosis flow 601 formed in accordance with the order of the confirmation items in a case where the operator manually performs the diagnosis as illustrated in the description display screen 600 of FIG. 6.

According to the present embodiment, in addition to the effects described in the first embodiment, the diagnosis reason will be described using the diagnosis flow at the time of manual diagnosis, so that the diagnosis result can be easily understood. In addition, since it is possible to explain the diagnosis reason in association with the diagnosis knowledge including the combination and the order of the plurality of confirmation items on the abnormality diagnosis processing flow, it is possible to enhance the interpretability of the diagnosis result.

### Third Embodiment

s a third embodiment of the present invention, an abnormality diagnosis device capable of creating a description presentation model by training from an abnormality history in a case where the description presentation model does not exist in advance will be described.

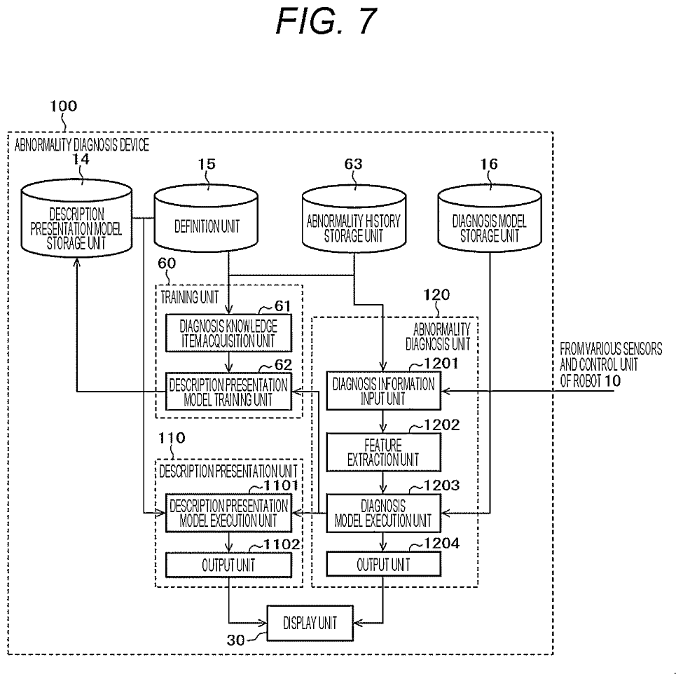

FIG. 7 illustrates a configuration of an abnormality diagnosis device 100 according to the present embodiment. In FIG. 7, the same components as those of the abnormality diagnosis device 10 of FIG. 1 described in the first embodiment are denoted by the same reference numerals, and the description thereof will be omitted. Also in the abnormality diagnosis device 100 illustrated in FIG. 7, since the configuration of receiving signals from various sensors attached to the robot 20 as an abnormality diagnosis target is the same as the configuration illustrated in FIG. 1 of the first embodiment, the configuration of the robot 20 illustrated in FIG. 1 is omitted in FIG. 7.

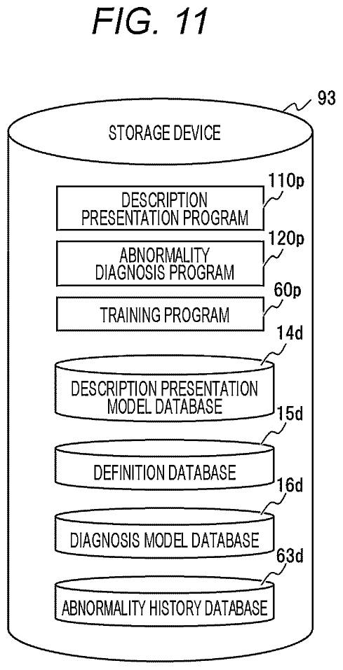

The abnormality diagnosis device 100 is also realized by the information processing device 90 as illustrated in FIG. 9, and FIG. 11 illustrates programs and data stored in the storage device 93. Each of a description presentation program 110p, an abnormality diagnosis program 120p, and a training program 60p is loaded into the memory 92 and executed by the processor 91, thereby causing the processor 91 to function as a description presentation unit 110, an abnormality diagnosis unit 120, or a training unit 60. Data stored in the description presentation model storage unit 14, the definition unit 15, the diagnosis model storage unit 16, and the abnormality history storage unit 63 are stored in the storage device 93 as a description presentation model database 14d a definition database 15d, a diagnosis model database 16d, and an abnormality history database 63d, respectively.

The abnormality diagnosis device 100 illustrated in FIG. 7 according to the present embodiment is different from the configuration of the abnormality diagnosis device 10 according to the first embodiment illustrated in FIG. 1 in that the training unit 60 and the abnormality history storage unit 63 are provided.

The abnormality history storage unit 63 is a storage unit that holds past abnormality cases, and stores past diagnosis information and corresponding diagnosis results.

The configuration of the abnormality diagnosis unit 120 is the same as that of the abnormality diagnosis unit 12 described in the first embodiment, but a part of the processing is different. Hereinafter, only different processing will be described.

A diagnosis information input unit 1201 is an input unit which reads past diagnosis information stored in the abnormality history storage unit 63 and passes the diagnosis information to a feature extraction unit 1202.

The processing of a diagnosis model execution unit 1203 is the same as that of the first embodiment, but the processing information is sent to a description presentation model training unit 62 of the training unit 60.

The training unit 60 is a functional unit which trains a description presentation model and executes processing of storing the trained description presentation model in the description presentation model storage unit 14, and includes a diagnosis knowledge item acquisition unit 61 and the description presentation model training unit 62 as sub-functional units.

The diagnosis knowledge item acquisition unit 61 reads the diagnosis knowledge from the definition unit 15, and acquires the diagnosis knowledge item corresponding to the past diagnosis information/diagnosis result stored in the abnormality history storage unit 63 based on the read diagnosis knowledge. For example, when the diagnosis knowledge read from the definition unit 15 is in the form of the abnormality diagnosis flow 601 of FIG. 6 and the past diagnosis result is “periodic maintenance target”, the diagnosis knowledge item is obtained as a diagnosis path 602 connecting “occurrence of gripping error” which is a route on the diagnosis flow and the diagnosis result “periodic maintenance target”.

The description presentation model training unit 62 executes processing of creating a machine learning model as a description presentation model and storing the model in the description presentation model storage unit 14. The machine learning model is trained so as to output the diagnosis knowledge item acquired by the diagnosis knowledge item acquisition unit 61 for the same past case using the processing information of the diagnosis model execution unit 1203 for a certain past case as an input.

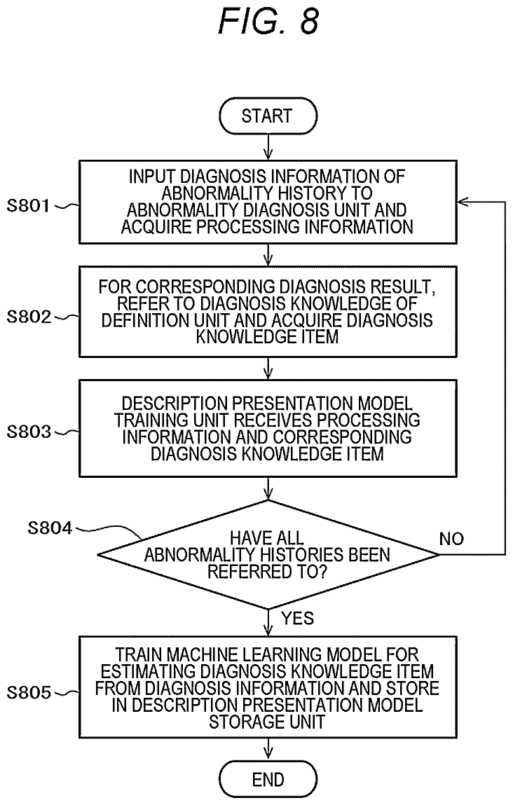

FIG. 8 illustrates an example of a flowchart corresponding to the flow of training processing in the training unit 60 of the present embodiment. This training processing is performed prior to the abnormality diagnosis process 500 and the description presentation process 510 described with reference to FIG. 5 in the first embodiment. Therefore, the processing flow illustrated in FIG. 8 is executed in a state where the diagnosis information input unit 1201 has no input of signals from the various sensors attached to the robot 20 and the control unit.

First, the diagnosis information input unit 1201 of the abnormality diagnosis unit 120 receives the diagnosis information from the abnormality history storage unit 63 (S801). Subsequently, the diagnosis knowledge item acquisition unit 61 receives a diagnosis result associated with the diagnosis information from the abnormality history storage unit 63 and acquires a corresponding diagnosis knowledge item with reference to the diagnosis knowledge of the definition unit 15 (S802).

Subsequently, the description presentation model training unit 62 receives the diagnosis knowledge item acquired by the diagnosis knowledge item acquisition unit 61 in association with the processing information processed by the diagnosis model execution unit 1203 based on the feature extracted by the feature extraction unit 1202 from the diagnosis information received by the diagnosis information input unit 1201 and the diagnosis information received by the diagnosis information input unit 1201 (S803).

It is checked whether all the abnormality histories stored in the abnormality history storage unit 63 have been referred to (S804), and in a case where not all the abnormality histories have been referred to yet (NO in S804), the processing returns to S801. On the other hand, in a case where the reference to all the abnormality histories is completed (YES in S804), the description presentation model training unit 62 trains the machine learning model for estimating the diagnosis knowledge item from the diagnosis information based on the received pair information of the processing information and the diagnosis knowledge item, stores the trained machine learning model in the description presentation model storage unit 14 (S805), and the processing ends.

After the training processing described with reference to FIG. 8 is completed, the abnormality diagnosis process 500 and the description presentation process 510 described with reference to FIG. 5 in the first embodiment are executed in a state where the signals from the various sensors 24 to 26 and the control unit 23 of the robot 20 are input to the diagnosis information input unit 1201, thereby performing the abnormality diagnosis of the robot 20.

According to the present embodiment, even in a case where the description presentation model is not stored in advance in the description presentation model storage unit 14, the training unit 60 can train the description presentation model by referring to the abnormality history stored in the abnormality history storage unit 63 and store the description presentation model in the description presentation model storage unit 14.

According to the present embodiment, in addition to the effects described in the first embodiment and the second embodiment, since the description presentation model can be created by machine learning even in a case where the description presentation model is not created in advance, labor for creating the description presentation model can be saved.

Note that the present invention is not limited to the above-described embodiments, and includes various modifications. For example, the above-described embodiments have been described in detail in order to simply describe the present invention, and are not necessarily limited to those having all the described configurations. In addition, a part of the configuration of a certain embodiment can be replaced with the configuration of another embodiment, and the configuration of another embodiment can be added to the configuration of a certain embodiment. In addition, it is also possible to add, delete, and replace other configurations for a part of the configuration of each embodiment.

### REFERENCE SIGNS LIST

10, 100 abnormality diagnosis device
11, 110 description presentation unit
12, 120 abnormality diagnosis unit
14 description presentation model storage unit
15 definition unit
16 diagnosis model storage unit
30 display unit
60 training unit
61 diagnosis knowledge item acquisition unit
62 description presentation model training unit
63 abnormality history storage unit
111, 1101 description presentation model execution unit
121, 1201 diagnosis information input unit
122, 1202 feature extraction unit
123, 1203 diagnosis model execution unit

1. An abnormality diagnosis device comprising:
an abnormality diagnosis unit which diagnoses an abnormality of a diagnosis target by using data related to the diagnosis target as an input;
a description presentation processing unit which presents a description corresponding to the abnormality of the diagnosis target based on a result of diagnosis by the abnormality diagnosis unit; and
a display unit which displays a description corresponding to the abnormality of the diagnosis target presented by the description presentation processing unit on a screen.

2. The abnormality diagnosis device according to claim 1, further comprising a diagnosis model storage unit which stores a machine learning model in which a relationship between a feature of data related to the diagnosis target and a diagnosis result is trained as a diagnosis model,
wherein the abnormality diagnosis unit diagnoses the abnormality of the diagnosis target using a feature extracted from related to the diagnosis target at a time of abnormality diagnosis and the diagnosis model stored in the diagnosis model storage unit, and outputs a diagnosis result of the diagnosis to the description presentation processing unit.

3. The abnormality diagnosis device according to claim 2, wherein
the diagnosis model stored in the diagnosis model storage unit is a neural network.

4. The abnormality diagnosis device according to claim 2, wherein
the diagnosis result is a factor of the abnormality.

5. The abnormality diagnosis device according to claim 2, wherein
the diagnosis result is a countermeasure to be taken against the abnormality.

6. The abnormality diagnosis device according to claim 1, wherein
the description presentation processing unit presents a diagnosis knowledge item related to the abnormality of the diagnosis target in association with the result of diagnosis of the abnormality, and
the display unit displays the result of diagnosis presented from the description presentation processing unit and a diagnosis knowledge item related to the abnormality associated with the result of diagnosis on the screen.

7. The abnormality diagnosis device according to claim 6, wherein
the description presentation processing unit further comprises: a definition unit which holds a diagnosis knowledge item; a description presentation model storage unit which holds a machine learning model based on a past abnormality case as a description presentation model; and a description presentation unit which presents a diagnosis knowledge item related to the abnormality of the diagnosis target in association with the result of diagnosis of the abnormality using processing information obtained by processing data related to the diagnosis target by the abnormality diagnosis unit and the description presentation model held in the description presentation model storage unit.

8. The abnormality diagnosis device according to claim 7, wherein
the diagnosis knowledge item held in the definition unit is relationship information between a confirmation item and the result of diagnosis in a case where an operator manually performs diagnosis of the diagnosis target.

9. The abnormality diagnosis device according to claim 7, wherein
the description presentation model stored in the description presentation model storage unit is a machine learning model obtained by training a correspondence between processing information obtained by processing a past abnormal case by the abnormality diagnosis unit and the diagnosis knowledge item held in the definition unit.

10. The abnormality diagnosis device according to claim 7, wherein
the description presentation processing unit further comprises a training unit, and the training unit trains a machine learning model for estimating the diagnosis knowledge item from the processing information by using processing information obtained by processing data related to the diagnosis target by the abnormality diagnosis unit and the diagnosis knowledge item held in the definition unit, and stores the trained machine learning model.

11. The abnormality diagnosis device according to claim 1, wherein
the display unit displays the description corresponding to the abnormality of the diagnosis target presented by the description presentation processing unit on a screen in association with a flow of processing in a case where an operator manually performs diagnosis of the diagnosis target.

12. An abnormality diagnosis method for diagnosing an abnormality of a diagnosis target using an abnormality diagnosis device comprising an abnormality diagnosis unit, a description presentation processing unit, and a display unit,
the abnormality diagnosis method comprising:
diagnosing an abnormality of the diagnosis target by the abnormality diagnosis unit using data related to the diagnosis target as an input;
presenting a description corresponding to the abnormality of the diagnosis target by the description presentation processing unit based on a result of diagnosis by the abnormality diagnosis unit; and
displaying a description corresponding to the abnormality of the diagnosis target presented by the description presentation processing unit on a screen of the display unit.

13. The abnormality diagnosis method according to claim 12, comprising:
presenting, by the description presentation processing unit, a diagnosis knowledge item related to the abnormality of the diagnosis target in association with a diagnosis result of the abnormality; and
displaying a diagnosis result of the abnormality presented from the description presentation processing unit and a diagnosis knowledge item related to the abnormality associated with the diagnosis result on the screen of the display unit.

14. The abnormality diagnosis method according to claim 12, wherein
the abnormality diagnosis device further comprises a description presentation model storage unit,
the abnormality diagnosis method comprising presenting, by the description presentation processing unit, a diagnosis knowledge item related to the abnormality of the diagnosis target as a description corresponding to the abnormality of the diagnosis target in association with a diagnosis result of the abnormality by using processing information obtained by processing data related to the diagnosis target by the abnormality diagnosis unit and the description presentation model held in the description presentation model storage unit which holds a machine learning model based on a past abnormality case as a description presentation model.

15. The abnormality diagnosis method according to claim 12, comprising displaying a description corresponding to the abnormality of the diagnosis target presented by the description presentation processing unit on the screen of the display unit in association with a flow of processing in a case where an operator manually performs diagnosis of the diagnosis target.

16. The abnormality diagnosis method according to claim 13, wherein
the abnormality diagnosis device further comprises a definition unit,
the abnormality diagnosis method comprising training, by the description presentation processing unit, a machine learning model for estimating the diagnosis knowledge item from the processing information by using the processing information obtained by processing data related to the diagnosis target by the abnormality diagnosis unit and the diagnosis knowledge item held in the definition unit, and storing the trained machine learning model.
